(19) United States
(12) Patent Application Publication
(10) Pub. No.: US 2015/0240638 A1
(43) Pub. Date: Aug. 27, 2015

(54) TECHNIQUE FOR APEX-SEAL PROFILE DESIGN

(71) Applicant: The Regents of The University of California, Oakland, CA (US)

(72) Inventors: Daniel C. H. Yang, Santa Monica, CA (US); Sarah Warren Rose, Valley Village, CA (US)

(73) Assignee: The Regents of The University of California, Oakland, CA (US)

(21) Appl. No.: 14/424,423

(22) PCT Filed: Aug. 28, 2013
(86) PCT No.: PCT/US13/57113

§ 371 Date: Feb. 26, 2015

Related U.S. Application Data
(60) Provisional application No. 61/696,023, filed on Aug. 31, 2012.
(60) Provisional application No. 61/696,072, filed on Aug. 31, 2012.

(51) Int. Cl. F01C 19/02; F01C 1/22; G06F 17/50; F01C 21/08

(52) U.S. Cl. CPC F01C 19/02; F01C 21/08; F01C 1/22; G06F 17/5086

(57) ABSTRACT

A method for designing an apex seal, a rotor housing, and a rotor includes defining a rotor radius describing a distance between a rotor housing and a specified point within a rotor pitch curve p1, defining a switch angle describing a portion of an apex seal of the rotor to contact the rotor (START) housing, and identifying a generating curve g1 from the rotor radius and the switch angle. A conjugate curve g2 represents an envelope of patterns traced by the generating curve g1 as the rotor pitch curve p1 is moved along a housing pitch curve p2. A rotor flank curve g3 represents an inside envelope of patterns traced by the conjugate curve g2 as the housing pitch curve p2 is moved along the rotor pitch curve p1. Curves g1, g2, and g3 may represent profiles of an apex seal, a rotor housing, and a rotor, respectively.

### CROSS-REFERENCE TO RELATED APPLICATION

This application claims the benefit of U.S. Provisional Patent Applications 61/696,023 filed Aug. 31, 2012 to Warren et al., titled “Rotary Engines with Apex-Seal-Profile-Conformed Housing,” and 61/696,072 filed Aug. 31, 2012 to Warren et al., titled “Multi-Apex-Seal Grid for Rotary Engines,” the contents of which are incorporated herein in their entirety.

### BACKGROUND

Conventional rotary engine profiles are based on a two-lobed epitrochoid and its inside envelope, which define the housing bore profile and rotor profile, respectively. Such a rotor design has three apexes that maintain contact with the housing throughout the planetary rotation, thereby defining three chambers. For practical applications, instead of the true trochoid and its envelope, a parallel trochoid is used with a parallel envelope, leaving some space between the engine housing and rotor. To seal the three chambers, sliding apex seals are inserted into the rotor apexes. However, the rotary engine has an inherent sealing disadvantage when compared with a reciprocating piston engine, and the challenge of effective apex sealing has prevented the rotary engine from achieving the same efficiency as piston engines. Further, apex seals used in rotary engines are prone to damage and failure more frequently than piston rings.

Thus, it would be beneficial to improve the sealing function of apex seals. It would be further beneficial to reduce the stress on the apex seals, thereby reducing damage to the seals.

### SUMMARY

In one aspect, a method for designing a rotor includes defining a rotor radius describing a distance between a rotor housing and a specified point within a rotor pitch curve p1, defining a switch angle describing a portion of an apex seal of the rotor to contact the rotor housing, and identifying a generating curve g1 from the rotor radius and the switch angle. The method further includes creating a conjugate curve g2 representing an envelope of patterns traced by the generating curve g1 as the rotor pitch curve p1 is moved along a housing pitch curve p2, and creating a rotor flank curve g3 representing an inside envelope of patterns traced by the conjugate curve g2 as the housing pitch curve p2 is moved along the rotor pitch curve p1. The method further includes determining a rotor profile based on the rotor flank curve g3.

In one embodiment, the method further includes determining a rotor housing profile based on the conjugate curve g2.

The generating curve g1 may be in the form of an arc, but may alternatively have a non-arc form.

The generating curve g1 may represent a profile of a rotor seal. The rotor seal may be implemented as multiple seals each having a seal profile, and the profile of the rotor seal represented by generating curve g1 is an outside envelope of the seal profiles. The rotor profile may include slots, each slot configured for positioning a seal. A seal may be movable within a slot, and a spring within a slot may be configured to exert pressure on the seal.

The g2 curve may be constrained such that the curve normal angle is continuously differentiable.

The number of rotor lobes may be three, and the rotor may be designed for use in a rotary engine with a 2:3 gear ratio.

In another aspect, a rotor includes a rotor body having a complex rotor profile including multiple apexes. One or more slots are positioned at each of the apexes. The rotor further includes multiple seals, and each seal is positioned within a slot, such that each apex includes at least one seal. At least one of the seals at each apex has a seal profile described in part by a switch angle and a radius of the rotor body, and the rotor profile is determined based in part on a portion of the seal profile.

In one embodiment, the rotor may include one or more springs positioned in each slot, configured to exert a force against a seal positioned within the slot. In one embodiment, at least two slots are positioned at each apex, and each slot includes a seal.

The seal profile may include profiles of multiple seals.

In another aspect, a method of designing a rotor seal profile includes selecting a number of lobes, defining a pitch curve having radius r1, and defining a deviation function e1(θ) representing, for each pitch curve point at an angle θ (theta), a radius of a circle centered at the pitch curve point. The method further includes identifying an envelope curve that describes an envelope of the deviation function e1(θ), determining a curve normal function ψ(θ) related to the envelope curve, and determining a seal curve g1 from the envelope curve and the curve normal function, where the seal curve g1 represents a portion of the rotor seal profile.

The seal curve g1 may be in the form of an arc, but may alternatively have a non-arc form.

The method may include calculating a function g1(x,y) for an arc seal, where g1(x)=r1(cos θ)+(e1(θ)) (cos ψ); and g1(y)=r1(sin θ)+(e1(θ)) (sin ψ).

The seal profile width may be greater than 2 mm, and further may be greater than 10 mm, greater than 30 mm, or greater than 40 mm.

### BRIEF DESCRIPTION OF THE FIGURES

FIG. 1A depicts a computer-aided-design drawing of a conventional Wankel-style rotary engine.

FIG. 1B depicts a line drawing of a conventional Wankel-style rotary engine.

FIGS. 2A-2P illustrate operation of a rotary engine through the Otto stages of combustion.

FIG. 3 illustrates an example of a technique for rotary engine design.

FIGS. 4A-4D illustrate examples of rotary engines designed from arc profile apex seals.

FIGS. 5A-5D illustrate examples of rotary engines designed from non-arc profile apex seals.

FIG. 6 illustrates an example of a deviation-function technique.

FIG. 7A illustrates a technique for apex seal profile design.

FIG. 7B illustrates relative orientation for the technique of FIG. 7A.

FIG. 8 illustrates a technique for rotary engine housing profile design.

FIG. 9 illustrates a technique for rotary engine housing profile design.

FIG. 10 illustrates a technique for rotary engine rotor design.

FIG. 11 illustrates a technique for apex seal arc profile design.

FIGS. 12A-12C illustrate examples of rotary engine housing profile designs based on apex seal arc profile designs.

FIG. 13 illustrates a technique for apex seal non-arc profile design.

FIGS. 14A-14C illustrate examples of rotary engine housing profile designs based on apex seal non-arc profile designs.

FIG. 15 illustrates an example of a rotary engine designed based on a wide apex seal profile design.

FIGS. 16A-16B illustrate an example of implementing an apex seal profile design as three seals.

FIG. 17 illustrates an example of a three-seal multiple-seal profile design in operation.

FIGS. 18A-18B illustrate an example of implementing an apex seal profile design as five seals.

FIG. 19 illustrates an example of a five-seal multiple-seal profile design in operation.

### DETAILED DESCRIPTION

Some mechanisms include seals between two surfaces to maintain close contact between the surfaces. In some embodiments, one of the surfaces includes an apex, and a seal is positioned at the apex. Such a seal is referred to as an apex seal. A non-limiting example of a surface including an apex and an apex seal is the rotor of a rotary engine, which conventionally has three apexes and correspondingly three apex seals. As the rotor turns within the rotor housing, the apex seals maintain contact with the inner surface of the rotor housing. Rotary engines may be used, for example, in internal combustion engines, compressors, generators, and superchargers. Rotary engines may be any of a variety of sizes, and may be implemented as micro electro-mechanical system (MEMS).

To increase the contact between an apex seal and an opposing surface, the profile of the apex seal may be designed for maximum contact with the opposing surface throughout a path of travel. Further, the profile of the opposing surface may be designed based on the profile of the apex seal.

In certain embodiments related to design of a rotary engine, presented by way of example, a deviation-function (DF) technique is used to determine the profile of an apex seal, which is used to design the profile of a conjugate housing, and the profile of the housing is then used to determine the profile of conjugate rotor flanks Because the engine housing design is based on the apex profile, better housing-to-rotor conformity may be possible, and therefore sealing capability may be improved. Improved apex sealing may improve engine efficiency, and may further reduce the forces on the apex seals, reducing wear on the seals and the inside surface of the housing. The determined profiles may be implemented in apex seals, housing, and/or rotor, of which one or more may be used in place of the respective conventional components.

In certain embodiments, use of the DF technique provides for apex seal variety, including different sizes of apex seal and the use of multiple apex seals at a single apex. Multiple apex seals include multiple parallel apex seals and multiple apex seals in a grid.

Apex seal profiles designed using the DF technique may be in the form of an arc, but may alternatively have a non-arc form.

While certain conditions and criteria are specified herein, it should be understood that these conditions and criteria apply to some embodiments of the disclosure, and that these conditions and criteria can be relaxed or otherwise modified for other embodiments of the disclosure.

An embodiment of the DF technique relates to a non-transitory computer-readable storage medium having computer code thereon for performing various computer-implemented operations. The term “computer-readable storage medium” is used herein to include any medium that is capable of storing or encoding a sequence of instructions or computer codes for performing the operations, methodologies, and techniques described herein. The media and computer code may be those specially designed and constructed for the purposes of the invention, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (“ASICs”), programmable logic devices (“PLDs”), and ROM and RAM devices. Examples of computer code include machine code, such as produced by a compiler, and files containing higher-level code that are executed by a computer using an interpreter or a compiler. For example, an embodiment of the invention may be implemented using Java, C++, or other object-oriented programming language and development tools. Additional examples of computer code include encrypted code and compressed code. Moreover, an embodiment of the invention may be downloaded as a computer program product, which may be transferred from a remote computer (e.g., a server computer) to a requesting computer (e.g., a client computer or a different server computer) via a transmission channel. Another embodiment of the invention may be implemented in hardwired circuitry in place of, or in combination with, machine-executable software instructions.

The DF technique is illustrated in the following discussion by way of the example of a rotary engine. A conventional Wankel-style rotary engine is first described in an introductory discussion to illustrate the components and function of a rotary engine. The DF technique is then described for improving apex seal design generally, and for the specific example of improving rotary engine design.

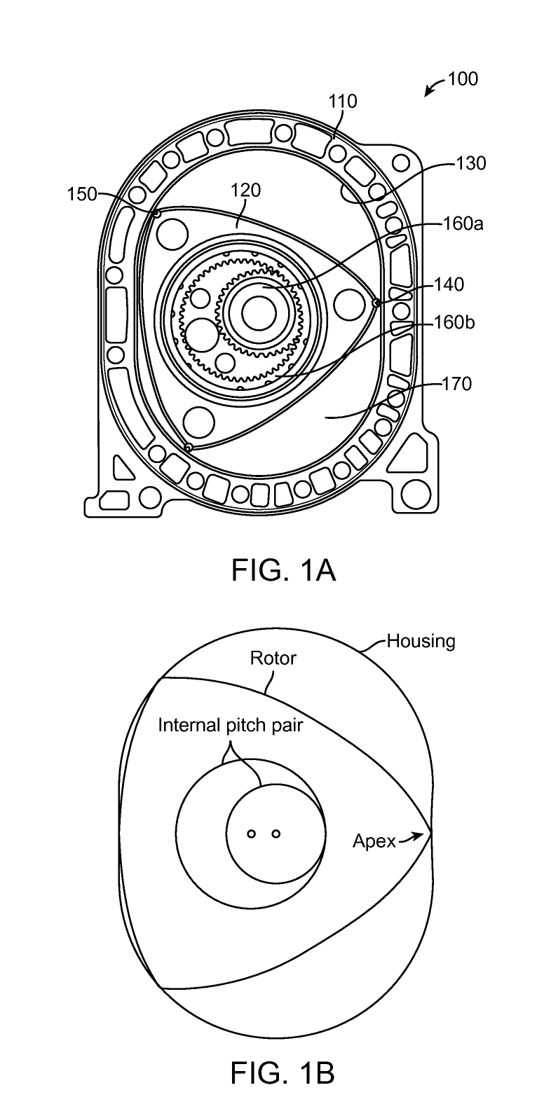

FIG. 1A is a computer-aided drawing (CAD) profile depiction 100 of a housing 110 and a rotor 120 of a conventional Wankel-style rotary engine. Housing 110 includes inner surface 130. Rotor 120 has three apexes 140, and an apex seal 150 positioned at each apex 140. A gear pair 160a and 160b determines in part the motion of rotor 120 within housing 110. Gear 160a is fixed, and gear 160b “walks” along gear 160a to provide some control over the motion of rotor 120. As rotor 120 moves within housing 110, apex seals 150 ideally make continuous contact with inner surface 130 to form three chambers 170 for a four-stage combustion cycle (an “Otto cycle”) of intake-compression-ignition-exhaust. However, as Wankel-style engine design is less than ideal, leakage occurs between chambers 170 past apex seals 150.

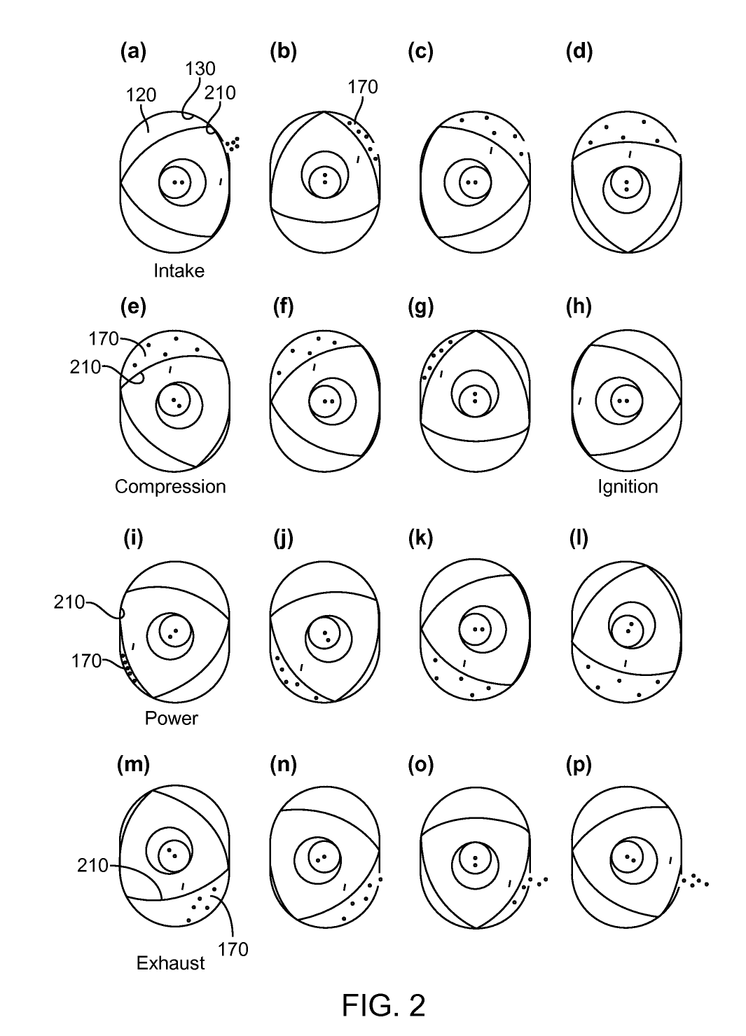

FIG. 1B is a line-drawing depiction of a conventional Wankel-style rotary engine such as the one illustrated in FIG. 1A, provided for better understanding of the illustrations in FIG. 2.

FIG. 2 illustrates a four-stage combustion cycle along one flank 210 of rotor 120 during one revolution of flank 210. Because rotor 120 has three flanks, the four-stage combustion cycle will occur concurrently, in different stages, at each of the three flanks In FIG. 2, energy is represented by five small circles, although in different stages, the energy may be in a different form.

Steps (a)-(d) of FIG. 2 illustrate intake, where energy in the form of fuel is pulled into chamber 170 formed between flank 210 and housing surface 130. As flank 210 rotates, chamber 170 enlarges to accommodate more fuel.

Steps (e)-(g) of FIG. 2 illustrate compression, where the fuel is compressed by the restriction of chamber 170 as flank 210 continues to rotate.

Step (h) of FIG. 2 illustrates that ignition occurs when the fuel is compressed to nearly a minimum volume. The ignition causes a force on flank 210.

Steps (i)-(1) of FIG. 2 illustrate that the power from expansion of the fuel due to ignition causes flank 210 to continue to rotate, allowing the ignited fuel to expand in chamber 170.

Steps (m)-(p) of FIG. 2 illustrate that the expended fuel is allowed to exhaust, and is forced out of chamber 170 as rotation of flank 210 causes chamber 170 to reduce to nearly a minimum volume.

Following exhaust, flank 210 continues to rotate and the cycle begins again.

As noted, the apex seals of a conventional rotary engine allow leakage between chambers due to the design of the engine. Moreover, because each side of a rotor apex is experiencing different stresses due to the different cycle stage occurring on each side of the apex, the apex seals are moved about within their respective rotor apex, causing further leakage. For the rotary engine example, the DF technique provides for an improved apex seal, by first designing an apex seal, then designing the housing and rotor for improved contact with the seal. The DF technique allows the consideration of a desired apex seal profile in the first instance, rather than fitting an apex seal to an existing rotary engine design at a later step, as is conventional.

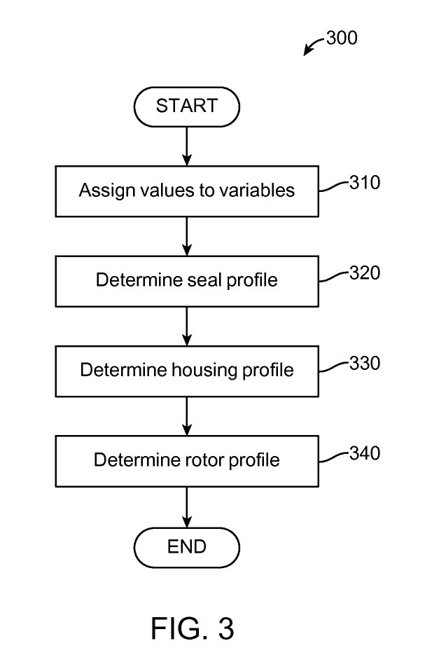

FIG. 3 illustrates, as a process 300, a high-level overview of the DF technique for the example of rotary engine design. Process 300 begins at block 310 by assigning values to design variables. In some embodiments, default values may be used if values are not assigned. Design variables include number of lobes in the engine, gear ratio, pitch curve, distance from a point on the pitch curve to a housing surface, gear travel equation variables, and switch angle, among others.

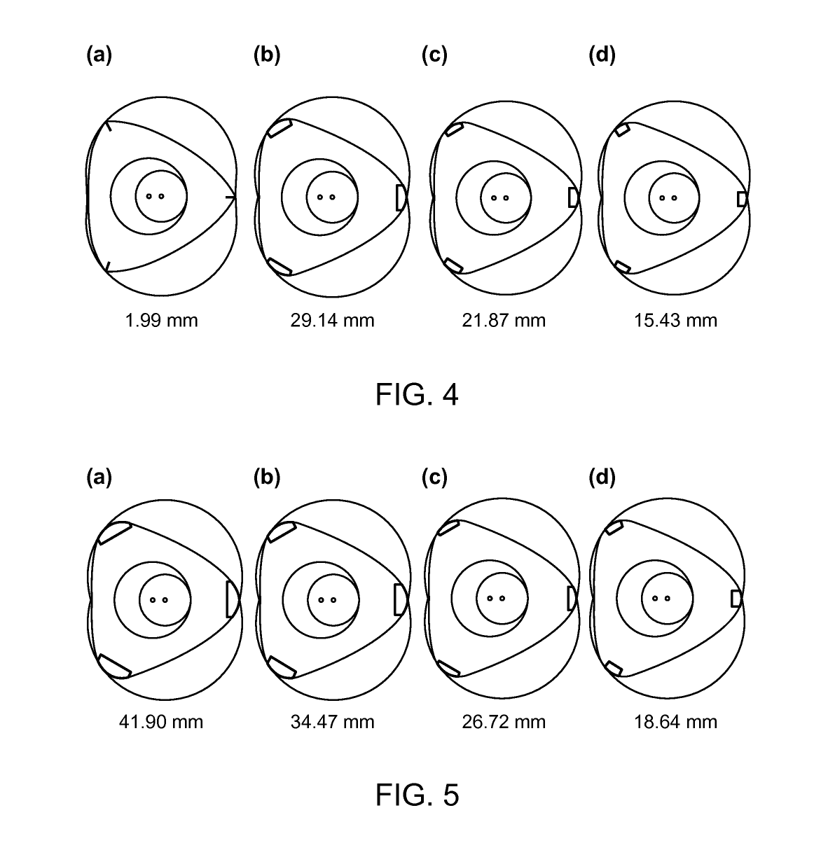

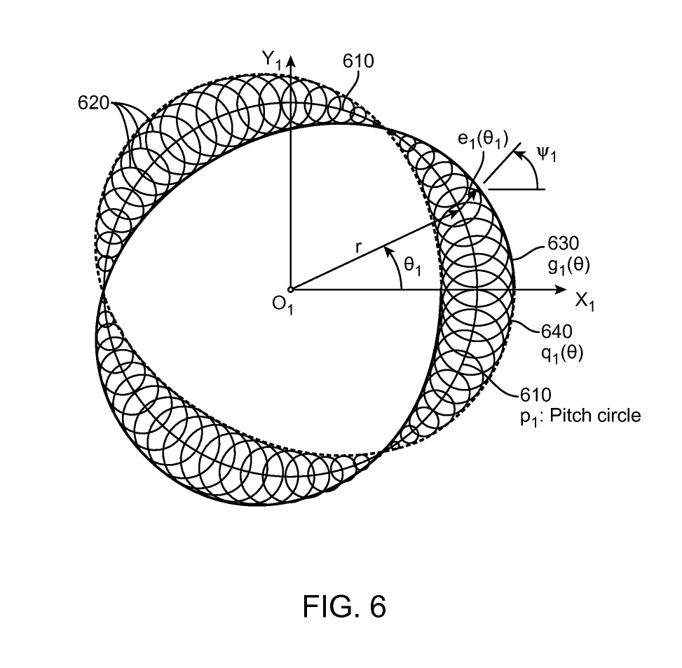

Process 300 continues at block 320 to determine an apex seal profile, then continues to block 330 to determine a housing profile, then continues at block 340 to determine a rotor profile. Details of the determination of apex seal profile, housing profile, and rotor profile are provided below. FIGS. 4A-4D and 5A-5D provide examples of rotary engines designed using the DF technique. The base DF technique is described with respect to FIG. 6.

FIGS. 4A-4D illustrate examples for varying widths of arc profile apex seals.

FIGS. 5A-5D illustrate examples for varying widths of non-arc profile apex seals.

FIG. 6 illustrates an original circular pitch curve 610 (labeled p1) with radius ‘r’. The reference frame X₁-O₁-Y₁ is anchored at the geometrical center (i.e., O₁) of pitch curve 610. A deviation function e₁(θ) represents the radius of a circle at each angular position on the pitch curve. The magnitude of deviation function e₁(θ₁) at angle θ₁ is illustrated in FIG. 6. The magnitude of the deviation function is shown by representative deviation circles 620, whose centers are located on pitch curve 610. An envelope 630 (labeled g₁(θ)) of the deviation circles is illustrated with a heavy solid line, and an envelope 640 (labeled q₁(θ)) of the deviation circles is illustrated with a heavy dashed line.

The common curve normal between the circles 620 and envelope 630 is ψ₁ (a function of angle θ), illustrated by ψ₁(θ₁) for angle θ₁ in frame X₁Y₁ of FIG. 6.

The curve normal ψ₁ may be found by solving the following equation derived from envelope theory:

$$sin ( {ψ}_{1} - {θ}_{1} ) = - \frac{{{e}_{1} ( {θ}_{1} )}^{′}}{{r}_{1}} \qquad ( 1 )$$

There are two solutions for ψ₁, corresponding to the two envelopes 630 and 640:

$$\begin{matrix}\begin{matrix}{ψ}_{1} = {θ}_{1} - {sin}^{- 1} \frac{{e}_{1}^{′}}{{r}_{1}} \\ = {θ}_{1} + {sin}^{- 1} \frac{{e}_{1}^{′}}{{r}_{1}} + π\end{matrix} \\ where & ( 2 ) \\ {e}^{′} = \frac{d e}{d {θ}_{1}} & ( 3 )\end{matrix}$$

The equations used to determine g₁(θ₁)) are:

g₁ₓ=r₁ cos θ₁+e₁(θ₁)cos ψ₁

g_{1y}=r₁ sin θ₁+e₁(θ₁)sin ψ₁ (4)

The base DF technique has been shown to have advantages over conventional methods when applied to involute curves and rotary mechanisms. The following describes use of the DF technique to generate an apex seal profile. The apex seals of a rotary engine are curved metal inserts that are in contact with the engine housing as the rotor moves, and generally are the part of the rotor that has contact with the housing inside surface.

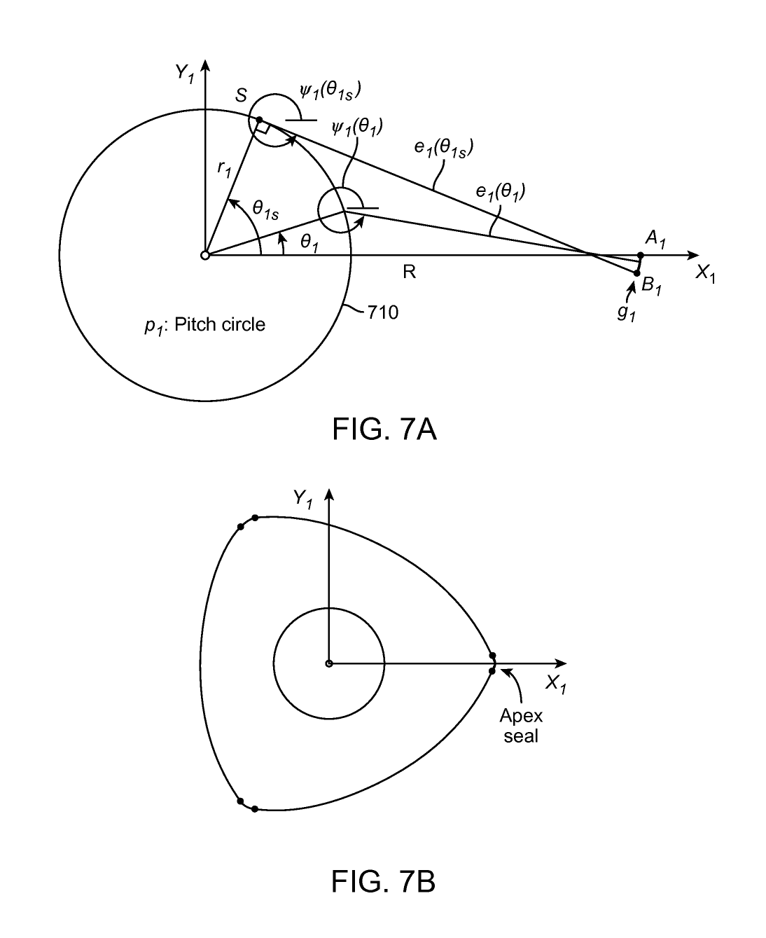

FIG. 7A illustrates application of the DF technique to apex seal design. In the illustration of FIG. 7A, a rotor pitch circle 710 (labeled p₁) is shown with orientation in relation to a rotor position as shown in FIG. 7B. An apex seal may be represented by a small curve about the X₁ axis, as illustrated in FIG. 7B. An apex seal may be described by an envelope, such as envelope 630 or 640 in FIG. 6, and a switch angle θ₁ₛ. As shown in FIG. 7A, a segment A₁B₁ is a portion g₁ of an envelope where A₁ lies on the X₁ axis and the length of A₁B₁ is defined by switch angle θ₁ₛ. Segment A₁B₁ represents a lower portion of an apex seal profile. Thus, an apex seal profile may be generated by the DF technique. Segment A₁B₁, denoted as generating curve g₁, may also be used to design a rotor housing.

Generating curve g₁ is defined in the pitch curve reference frame X₁-O₁-Y₁ with a concave shape of C¹ continuity. The position of generating curve g₁ along the X₁ axis (i.e., point A) is the rotor radius R. For generating curve g₁ to have C¹ continuity, the deviation function should satisfy:

$${e}_{1}^{′} ( 0 ) = \frac{d {e}_{1}}{d {θ}_{1}} ( 0 ) = 0 \qquad ( 5 )$$

The length of an apex seal is determined by the switch angle θ₁ₛ, which is the conjugating range of the seal. During a quarter rotation of the rotor inside the housing, the contact point between the seal and the housing travels along the apex seal from the true apex A₁ in FIG. 7A, to the farthest point B₁, and then back to A₁. The switch angle is the crankshaft position in the rotor's frame of reference (labeled S in FIG. 7A) at which the contact point reaches the farthest edge on the apex seal and reverses (switches) direction to return to the true apex. At switch angle θ₁ₛ, the line SB₁ is normal to generating curve g₁ and also tangent to pitch circle 710. Thus, at the switch point S:

$${ψ}_{1} ( {θ}_{1 s} ) - {θ}_{1 s} = \frac{3 π}{2} \qquad ( 6 )$$

From equation (1), this implies a geometric constraint on the deviation function:

$${e}_{1}^{′} ( {θ}_{1 s} ) = \frac{d {e}_{1}}{d {θ}_{1}} ( {θ}_{1 s} ) = {r}_{1} \qquad ( 7 )$$

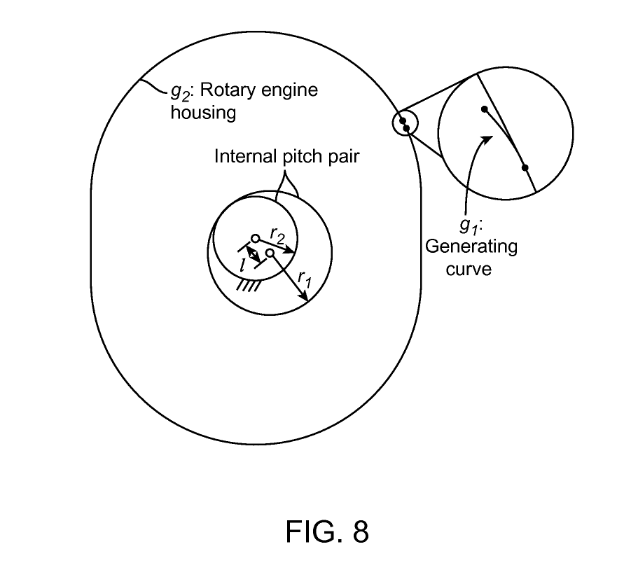

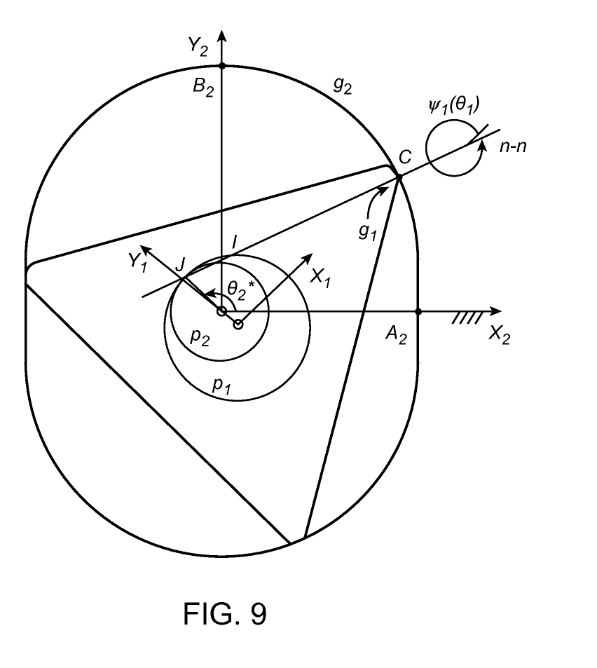

FIG. 8 illustrates how generating curve g₁ may be used to generate a conjugate curve g₂ representing the inside surface of a rotor housing. The generating curve g₁ reference frame is rolled around in the same manner as the rotor will rotate inside the housing. The internal pitch pair have the same radii ratio as the gears in the planned rotary engine, shown in FIG. 8 as having a ratio of approximately 2:3. The distance between the gear centers, denoted by V′ is referred to as the eccentricity.

FIG. 9 illustrates generation of a housing profile, described by conjugate curve g₂. The number of lobes on the rotor is n=3, which is also the number of enclosed chambers inside the housing. The housing pitch curve p₂ has a stationary reference frame X₂Y₂ and the rotor pitch curve p₁ has moving reference frame X₁Y₁. The pitch pair has rolling contact. As pitch curve p₁ rolls on pitch curve p₂, a family of curves emerges, whose envelope is the conjugate curve g₂ profile. The normal line n-n at point C is normal to both generating curve g₁ and conjugate curve g₂, and identifies two instant centers, I and J, according to the kinematics of direct contact. In FIG. 9, the current instant center is J and the previous instant center is I. This means that FIG. 9 illustrates a position of reverse contact, such that point C has travelled to the farthest point on the apex seal (a first trip) and is now returning to the beginning (a second trip). These two trips are referred to as forward contact and reverse contact. Forward contact is described by:

$${x}_{2} = {r}_{2} cos {θ}_{2} + {e}_{2} cos {ψ}_{2} \\ {y}_{2} = {r}_{2} sin {θ}_{2} + {e}_{2} sin {ψ}_{2} \\ where \\ {r}_{2} = {r}_{1} - l \\ {e}_{2} = {e}_{1} ( {θ}_{1} ) \\ {θ}_{2} = \frac{n}{n - 1} {θ}_{1} , \\ 0 \leq {θ}_{1} \leq {θ}_{is} \\ {ψ}_{2} = \frac{{θ}_{2}}{n} + {ψ}_{1} ( {θ}_{1} ) \qquad ( 8 )$$

Reverse contact is described by:

$${x}_{2}^{*} = {r}_{2} cos {θ}_{2}^{*} + {e}_{2}^{*} cos {ψ}_{2}^{*} \\ {y}_{2}^{*} = {r}_{2} sin {θ}_{2}^{*} + {e}_{2}^{*} sin {ψ}_{2}^{*} \\ where \\ {θ}_{2}^{*} = \frac{n}{n - 1} ( 2 {ψ}_{1} - {θ}_{1} - π ) \\ {ψ}_{2}^{*} = \frac{{θ}_{2}^{*}}{n} + {ψ}_{1} ( {θ}_{1} ) \\ {e}_{2}^{*} = {e}_{1} ( {θ}_{1} ) + IJ , \\ 0 \leq {θ}_{1} \leq {θ}_{ls} \\ IJ = 2 {r}_{1} cos ( {ψ}_{1} - {θ}_{1} ) \qquad ( 9 )$$

For θ*₂, the +π or −π corresponds to the g1 or q1 envelope, respectively (refer to FIG. 6.)

For a smooth engine housing profile, the forward and reverse contact should be continuous at switch angle θ₁ₛ. The conjugate curve g₂ will be smooth if the curve normal angle ψ₂(θ₂) is continuously differentiable. From the equations for the conjugate curve g₂, this is a constraint on ψ₁(θ₁). The function ψ₁(θ₁) decreases as θ₁ increases, reaching its minimum at the switch angle θ₁=θ₁ₛ. Therefore, at switch angle θ₁ₛ, when ψ₁(θ₁) reaches its minimum value and reverses direction, the following is true:

$${ψ}_{1}^{′} ( {θ}_{1 s} ) = \frac{d {ψ}_{1}}{d {θ}_{1}} ( {θ}_{1 s} ) = 0 \qquad ( 10 )$$

Differentiation both sides of equation (2) with respect to θ₁:

$$\frac{d {ψ}_{1}}{d {θ}_{1}} = 1 - \frac{{e}_{1}^{″}}{{r}_{1} cos ( {ψ}_{1} - {θ}_{1} )} \qquad ( 11 )$$

Evaluating equation (11) at θ₁=θ₁ₛ:

$$\begin{matrix}\frac{{e}_{1}^{″} ( {θ}_{1 s} )}{{r}_{1} cos ( {ψ}_{1} ( {θ}_{1 s} ) - {θ}_{1 s} )} = 1 \\ where & ( 12 ) \\ {ψ}_{1} ( {θ}_{1 s} ) - {θ}_{1 s} = 3 π / 2 \\ so that & ( 13 ) \\ {e}_{1}^{″} ( {θ}_{1 s} ) = 0 & ( 14 )\end{matrix}$$

### Applying L'Hopital's Rule

$${lim}_{{θ}_{1} \to {θ}_{1 s}} \frac{{e}_{1}^{″}}{{r}_{1} cos ( {ψ}_{1} - {θ}_{1} )} = {lim}_{{θ}_{1} \to {θ}_{1 s}} \frac{{e}_{1}^{′′′}}{- {r}_{1} sin ( {ψ}_{1} - {θ}_{1} ) ( {ψ}_{1}^{′} - {θ}_{1} )} = 1$$

results in the kinematic constraint on deviation function e₁:

e₁^{lll}(θ₁ₛ)=−r₁ (15)

Having determined a housing profile, a rotor profile may be found using conjugate curve g₂ to generate a lobe profile g₃, representing a half lobe of the rotor. Lobe profile g₃ is the inside envelope of moving conjugate curve g₂ as its pitch curve p₂, is rolled on pitch curve p₁. The inside envelope is determined by the forward contact portion of the conjugate curve g₂, denoted g_{2forward}, now the generating curve.

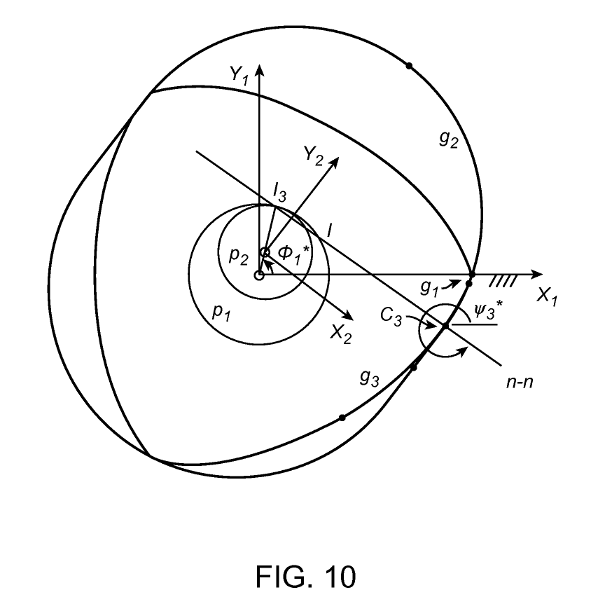

FIG. 10 illustrates generation of lobe profile g₃. There is pure rolling contact between pitch curves p₁ and p2, and the X₁Y₁ frame is stationary while X₂Y₂ is moving. The contact point C3 is a point on g_{2forward} and lobe profile g₃, and the normal line n-n has angle ψ*₃, as indicated. There are two instant centers, I and I₃, that fall on normal line n-n. The position shown has instant center I₃, and instant center I is a previous one. Analogous to the generation of the conjugate curve g₂, the contact on g_{2forward} is periodic. The forward contact portion returns the original generating curve g₁ (i.e., the lower portion of the apex seal profile), since this is the reverse of the process that generated g_{2forward} from generating curve g₁. The reverse contact portion provides the lobe profile g₃.

Forward contact is described by:

$${x}_{3} = {r}_{1} cos {φ}_{1} + {e}_{3} cos {ψ}_{3} \\ {y}_{3} = {r}_{1} sin {φ}_{1} + {e}_{3} sin {ψ}_{3} \\ where \\ {φ}_{1} = \frac{n - 1}{n} {θ}_{2} \\ {ψ}_{3} = {ψ}_{2} - \frac{{φ}_{1}}{n - 1} \\ {e}_{3} = {e}_{2} \qquad ( 16 )$$

Reverse contact is described by:

$${x}_{3}^{*} = {r}_{1} cos {φ}_{1}^{*} + {e}_{3}^{*} cos {ψ}_{3}^{*} \\ {y}_{3}^{*} = {r}_{1} sin {φ}_{1}^{*} + {e}_{3}^{*} sin {ψ}_{3}^{*} \\ where \\ {φ}_{1}^{*} = \frac{n - 1}{n} {θ}_{2} \pm π \\ {ψ}_{3}^{*} = {ψ}_{2} - \frac{{φ}_{1}^{*}}{n - 1} \\ {e}_{3}^{*} = {e}_{2} + {I}_{3} J \\ {I}_{3} I = 2 {r}_{2} sin ( {ψ}_{2} - {θ}_{2} ) \qquad ( 17 )$$

For φ*₁, the +π or −π corresponds to the g1 or q1 envelope, respectively (refer to FIG. 6.)

An apex seal arc profile will result from an arc-based deviation function. Equation (18) was derived for a circular arc generating curve.

e₁(θ₁)=\sqrt{a²+r₁²−2ar₁ cos(θ₁)}−ρ 0≦θ₁≦θ₁ₛ (18)

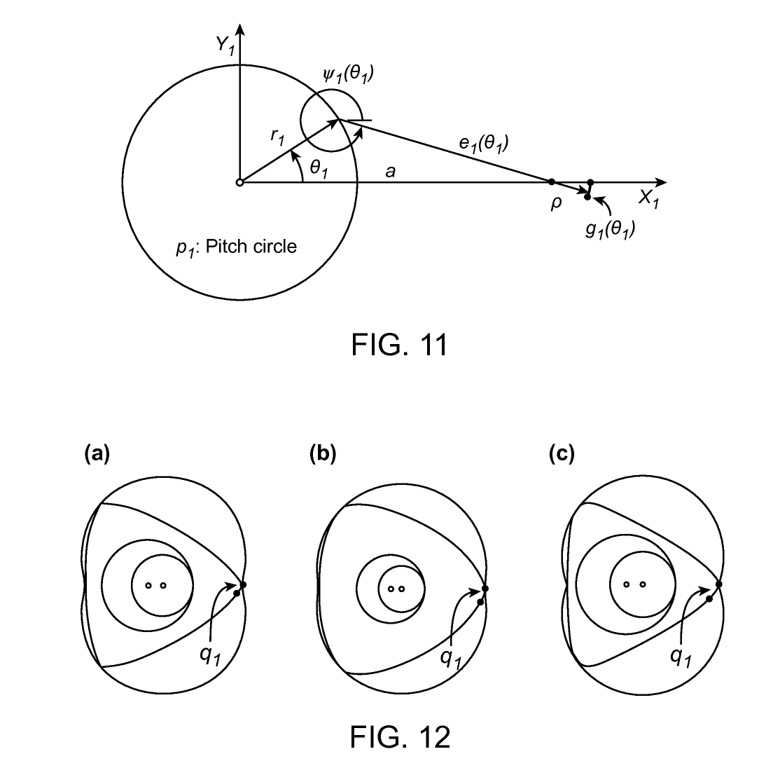

FIG. 11 illustrates a free parameter ρ representing the radius of the generating curve (arc) g₁, and therefore also the radius of the apex seal profile. A free parameter a is the distance between the pitch circle center and the arc center. The rotor radius is the distance between a and ρ (scaled to an eccentricity of 1), where ρ is negative for a concave generating curve.

The switch angle governs the conjugating range between the housing and the rotor, calculated by:

$${θ}_{1 s} = {cos}^{- 1} ( \frac{{r}_{1}}{a} ) . \qquad ( 19 )$$

FIGS. 12A-12C illustrate examples of resulting engine profiles for three different apex seal arc profiles. Table 1 provides the DF equation parameters corresponding to FIG. 12.

TABLE 1

| Figure | n | l | a | ρ | θ₁ₛ |
|---|---|---|---|---|---|
| 12a | 3 | 1 | 8 | −1 | 68° |
| 12b | 3 | 1 | 9 | −0.1 | 71° |
| 12c | 3 | 1 | 6 | −2 | 60° |

For conventional rotary engines, the number of lobes is n=3 and the pitch radii ratio is 2:3, so eccentricity l=1 for all of the examples. Eccentricity can be scaled. For other rotary mechanisms or modified rotary engines, n and l are parameters that can be chosen differently.

Non-arc apex seals may also be designed use the DF technique. For example, equation (20) is a sinusoidal deviation function that has an oval-shaped envelope and therefore results in an oval generating curve.

e₁(θ₁)=r₁(a₃ cos³θ₁+a₂ cos²θ₁+a₁ cos θ₁+a₀), 0≦θ₁≦θ₁ₛ (20)

The generating curves of this deviation function come from the inside envelope q₁(θ₁) of the deviation circles. After applying boundary conditions, the coefficients in this deviation function are:

$${a}_{3} = \frac{{cos}^{2} {θ}_{1 s}}{2 {sin}^{5} {θ}_{1 s}}$$

$${a}_{2} = \frac{cos {θ}_{1 s}}{2 {sin}^{3} {θ}_{1 s}} - 3 {a}_{3} cos {θ}_{1 s}$$

$${a}_{1} = \frac{1}{sin {θ}_{1 s}} - 3 {a}_{3} {cos}^{2} {θ}_{1 s} - 2 {a}_{2} cos {θ}_{1 s}$$

The free parameters for this deviation function are n, l,=θ₁ₛ, and a₀. For conventional rotary engines, n=3, and to maintain the same 2:3 gear ratio as in a conventional rotary engine, l=1 for r₁=nl and r₂=r₁−l.

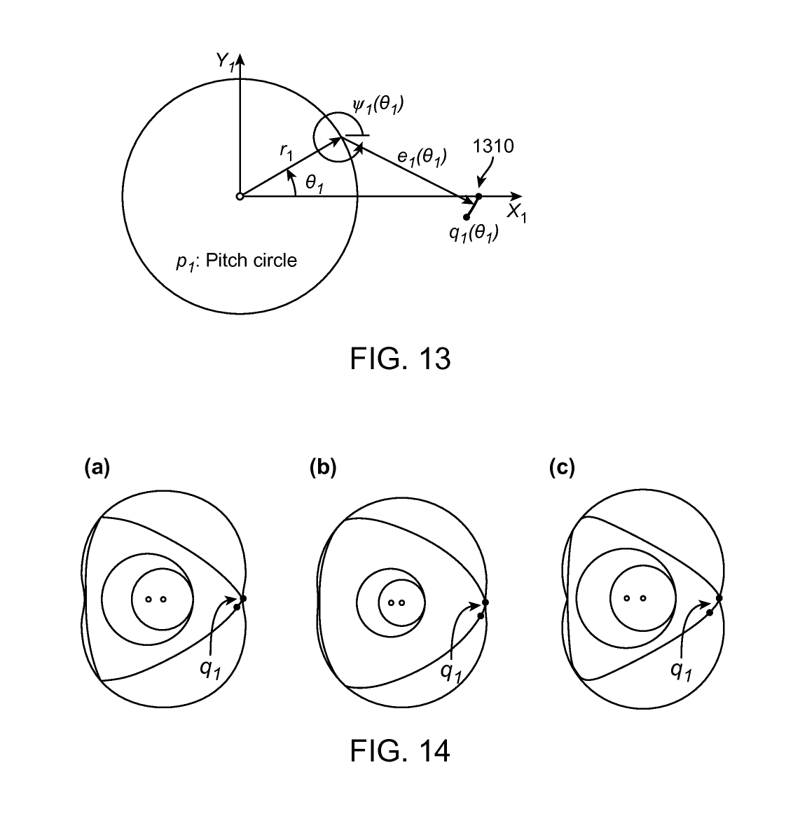

FIG. 13 illustrates a possible generating curve 1310 according to equation (20).

FIGS. 14A-14C illustrate examples of engine profiles for three different apex seal non-arc profiles. Table 2 provides the DF equation parameters corresponding to FIG. 14.

TABLE 2

| Figure | n | l | θ₁ₛ | a₀ |
|---|---|---|---|---|
| 14a | 3 | 1 | π/3.35 | −2.3 |
| 14b | 3 | 1 | π/3 | 3 |
| 14c | 3 | 1 | π/4 | −2.4 |

The conventional apex seal has a cylindrical surface in contact with the housing bore, designed to spread the contact region around the rotor's true apex and avoid a concentrated area of contact. But the conventional housing bore is designed for a rotor with single point contact at each of the three apexes. To reconcile the discrepancy between the apex profile and nonconforming housing profile, about 2 mm of clearance is inserted between the rotor and housing. This gap is closed by the apex seal, which moves radially in and out, as well as side-to-side in the slot that holds it. This movement may lead to separation between the seal and the bore under certain conditions. The apex seal may lose contact with the housing by sliding down inside the rotor slot, moving completely from one side of the slot to the other side, and tilting from one side of the slot to the other side. These movements by the seal are caused by the pressure changes inside the chambers on either side of the seal, especially a reversal of the side with higher pressure.

A wide apex seal may be designed to allow for greater contact with the housing using the DF technique as described above. Because generating curve g₁ is one half of the apex seal profile, the farther generating curve g₁ extends, the wider the seal.

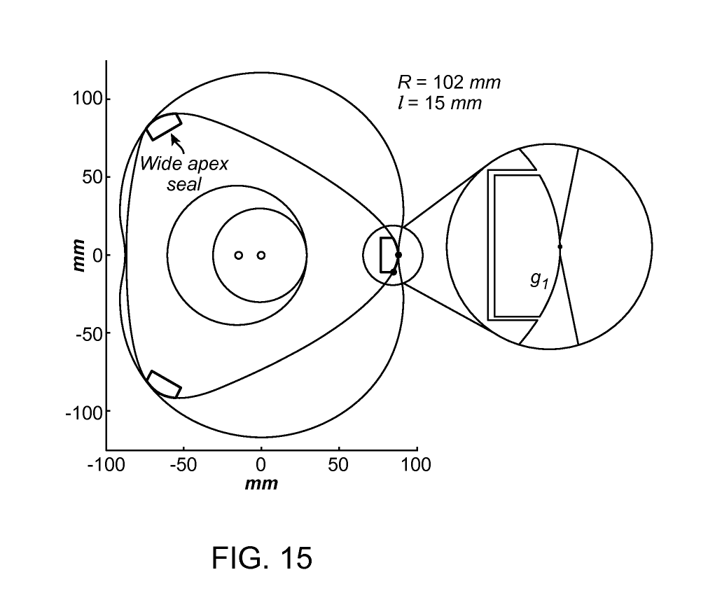

FIG. 15 illustrates generating curve g₁ relative to a rotor, housing, and wide apex seal.

To illustrate the design of wide apex seals, two deviation functions are examined here: an arc-based and a non-arc-based function. An arc-based deviation function in terms of the rotor radius, R=a+ρ, is:

e₁(θ₁)=\sqrt{(R−ρ)²+r₁²−2(R−ρ)r₁ cos(θ₁)}−ρ 0≦θ₁≦θ₁ₛ (21)

where ρ is the radius of the arc of the generating curve g₁ (and the radius of the apex seal.) Choosing a longer radius results in a wider seal. A non-arc-based deviation function was introduced previously as equation (20):

e₁(θ₁)=r₁(a₃ cos³θ₁+a₂ cos²θ₁+a₁ cos θ₁+a₀), 0≦θ₁≦θ₁ₛ

with coefficients determined after applying the boundary conditions of the DF technique:

$${a}_{3} = \frac{{cos}^{2} {θ}_{1 s}}{2 {sin}^{5} {θ}_{1 s}}$$

$${a}_{2} = \frac{cos {θ}_{1 s}}{2 {sin}^{3} {θ}_{1 s}} - 3 {a}_{3} cos {θ}_{1 s}$$

$${a}_{1} = \frac{1}{sin {θ}_{1 s}} - 3 {a}_{3} {cos}^{2} {θ}_{1 s} - 2 {a}_{2} cos {θ}_{1 s}$$

The adjustable parameter a₀ becomes:

$${a}_{0} = 1 - \frac{R}{{r}_{1}} - {a}_{3} - {a}_{2} - {a}_{1} \qquad ( 22 )$$

A range of the widest apex seals that can be achieved with these functions was presented in FIGS. 4 and 5 (for arc profile and non-arc profile seals, respectively), with corresponding parameters in Tables 3 and 4, respectively.

TABLE 3

| Figure | R | l | ρ | Seal width (mm) |
|---|---|---|---|---|
| 4a | 102 | 15 | −2.3 | 1.99 |
| 4b | 102 | 15 | −25 | 29.1446 |
| 4c | 102 | 15 | −20 | 21.8728 |
| 4d | 102 | 15 | −15 | 15.4315 |
| (not shown) | 102 | 15 | −10 | 9.6985 |
| (not shown) | 102 | 15 | −5 | 4.5512 |

TABLE 4

| Figure | R | l | θ₁ₛ (rad) | Seal width (mm) |
|---|---|---|---|---|
| 5a | 102 | 15 | 0.85 | 41.9022 |
| (not shown) | 102 | 15 | 0.88 | 37.4879 |
| 5b | 102 | 15 | 0.90 | 34.4772 |
| 5c | 102 | 15 | 0.95 | 26.7178 |
| 5d | 102 | 15 | 1.00 | 18.6358 |
| (not shown) | 102 | 15 | 1.02 | 15.3157 |

For the examples shown, the parameters for rotor radius, R, and eccentricity, l, are kept at those of Mazda's 12A rotary engine, which uses 2 mm seals. The designed equivalent of an engine profile with 2 mm seals using the DF technique is shown in FIG. 4A. As shown in FIG. 4B, the widest apex seals that can be achieved with the Mazda engine parameters using an arc profile seal are about 15 times wider than conventional apex seals. As shown in FIG. 5A, the widest apex seals that can be achieved with the Mazda engine parameters using a non-arc profile seal are about 14 times wider than conventional apex seals. Even wider seals are possible if eccentricity or rotor radius are adjusted. The width represents the range of contact the rotor has with the housing bore. For the conventional design method of a Wankel engine, the contact is a single point at the apex. Using the DF technique, the whole seal is conjugate from leading edge to trailing edge. The conventional apex seal profile is not conjugate to the Wankel engine housing profile, limiting the possible width of the apex seals.

In certain embodiments, to implement a multi-apex-seal sealing grid, first the DF technique is used to design a rotary engine profile for a single apex seal that represents a region of apex contact, where the width of the designed single apex seal is equal to the width of a set of narrower apex seals plus the spaces between them.

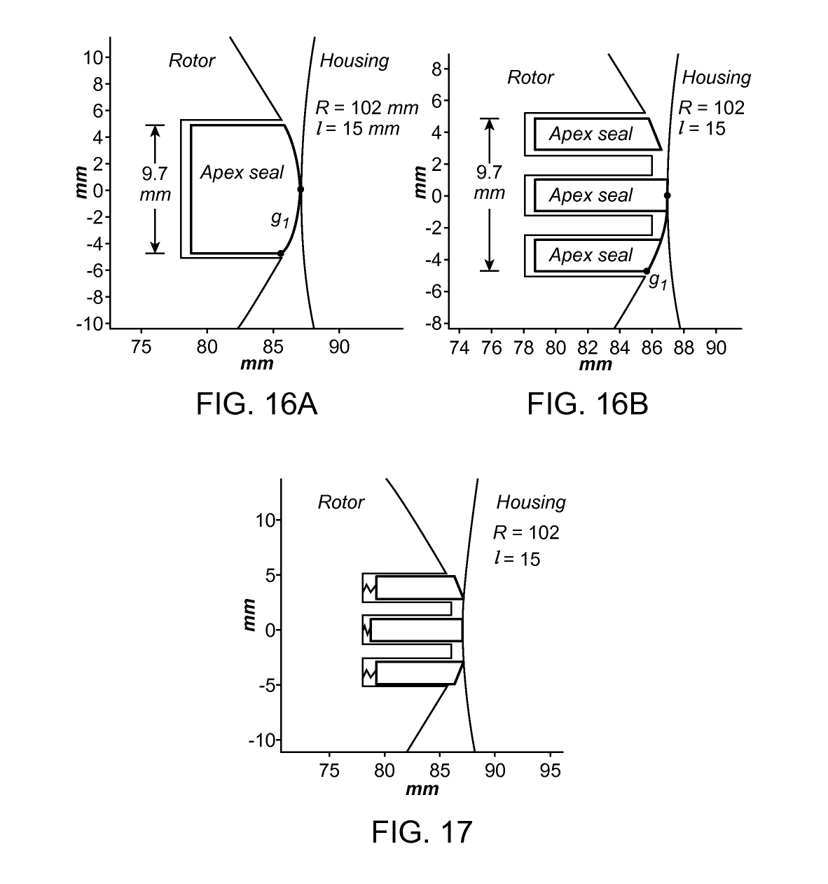

FIG. 16A illustrates a 9.7 mm wide apex seal designed using the DF technique with parameters for Mazda's 12A engine. The generating curve g₁ is shown (between the dots) as half of an apex seal profile. FIG. 16B illustrates the same generating curve g₁, where the seal profile is the same 9.7 mm wide but is implemented as three seals. The rotor includes a slot for each seal, such that there is a profile gap between seals. When the contact point between the rotor and housing is within a gap, there is no conjugate contact, but the seals on either side are in contact due to external forces. Generally, all of the seals in the multi-apex-seal system are continuously in contact with the housing bore due to the forces acting on the apex seals.

FIG. 17 illustrates an example of a three-seal configuration during operational conditions, with all three seals in contact with the housing. Springs are shown behind each of the seals to exert pressure against the seals, but the pressure forces from the adjacent chambers may be mainly responsible for the seal maintaining contact during rotation.

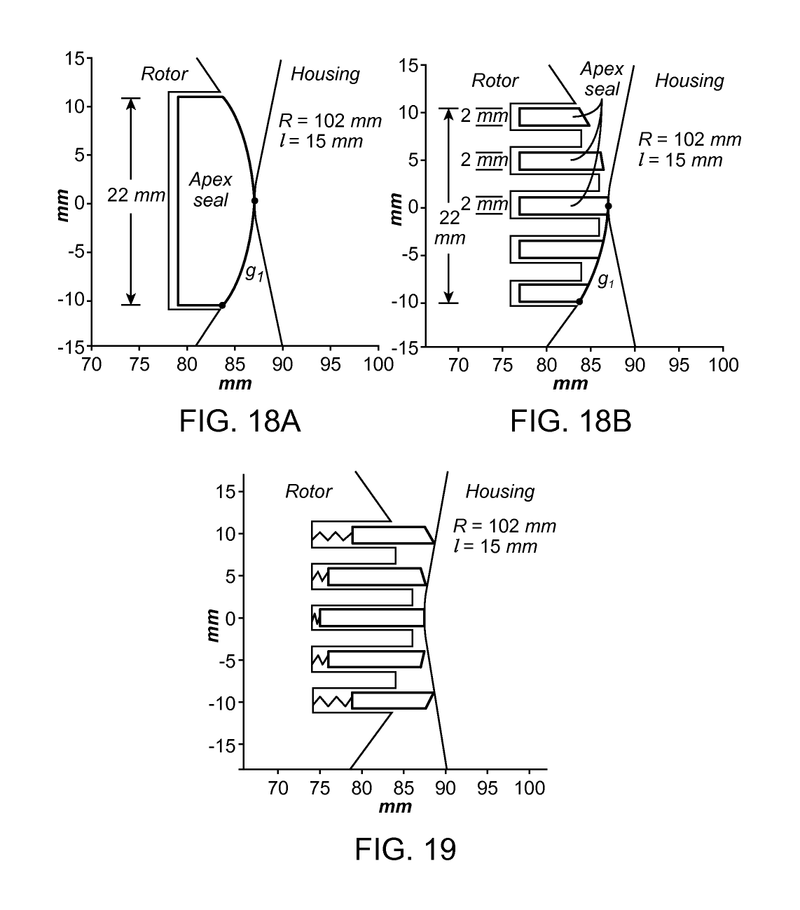

FIG. 18A illustrates an example of a 22 mm wide apex seal designed using the DF technique with parameters for Mazda's 12A engine. FIG. 18B illustrates the 22 mm apex seal profile implemented as five seals. FIG. 19 illustrates an example of a five-seal configuration during operational conditions, with all five seals in contact with the housing. For the rotor position shown, the middle seal is in conjugate contact, the secondary pair of seals, immediately above and below the middle seal, are extended partially beyond the g₁ curve, and the tertiary pair of seals at the outer edge of g₁ are extended the farthest. As the number of apex seals increases, the deeper the slots in the rotor and the taller the seals should be in order to prevent the edge seals from falling out. The necessary height of the seal can be determined by the switch angle position, which is the rotor position at which the contact point is at the extreme of the g₁ curve. When the seal farthest from the middle seal is in conjugate contact with the housing bore, the opposite seal, which is farthest away, is at maximum extension.

The examples shown above in FIGS. 16-19 are symmetrical such that the same number of apex seals are above and below the middle seal at the true apex of the rotor. Asymmetrical multi-apex-seal configurations are also possible, creating different sealing for different rotor positions. Also possible are different numbers of seals at each apex and different seal widths for apex seals of a rotor. The 2 mm industry standard for apex seals was used to illustrate some possible multi-seal designs, but wider or narrower seals may be used instead.

An advantage of using a multi-apex-seal is that it isolates each seal from pressure forces of a nonadjacent chamber. This eliminates the reversal of direction of the resultant force on the apex seal, allowing the seal to maintain contact with the housing instead of fluttering or floating inside the rotor slot.

### CONCLUSION

The DF technique described here is a new method for rotary engine design starting from the apex seal profile, incorporating the geometry of the apex seal into the design process. The DF technique can identify a greater variety of profiles than the conventional method of rotary engine design. The housing profiles generated by using the DF technique have an advantage over the conventional profiles because they are conjugate to the apex seal profile on which they are based. The conformity between the seal and the housing can be used to improve the sealing capability and effectiveness and thus improve engine efficiency. Another advantage is that forces on the apex seals can be reduced, thus reducing the wear on the seals and the housing. The reduced wear will increase the longevity of the seals and the overall engine.

As described with respect to the examples provided, the number of lobes and the eccentricity of the engine can be modified from conventional values, allowing for a wider range of design possibilities. By modifying these parameters, the DF technique can also be applied to other rotary mechanisms that use apex seals.

While the invention has been described with reference to the specific embodiments thereof, it should be understood by those skilled in the art that various changes may be made and equivalents may be substituted without departing from the true spirit and scope of the invention as defined by the appended claim(s). In addition, many modifications may be made to adapt a particular situation, material, composition of matter, method, operation or operations, to the objective, spirit and scope of the invention. All such modifications are intended to be within the scope of the claim(s) appended hereto. In particular, while certain methods may have been described with reference to particular operations performed in a particular order, it will be understood that these operations may be combined, sub-divided, or re-ordered to an equivalent method without departing from the teachings of the invention. Accordingly, unless specifically indicated herein, the order and grouping of the operations is not a part of the invention.

1. A method for designing a rotor, comprising:
defining a rotor radius describing a distance between a rotor housing and a specified point within a rotor pitch curve p1;
defining a switch angle describing a portion of an apex seal of the rotor to contact the rotor housing;
identifying a generating curve g1 from the rotor radius and the switch angle;
creating a conjugate curve g2 representing an envelope of patterns traced by the generating curve g1 as the rotor pitch curve p1 is moved along a housing pitch curve p2;
creating a rotor flank curve g3 representing an inside envelope of patterns traced by the conjugate curve g2 as the housing pitch curve p2 is moved along the rotor pitch curve p1; and
determining a rotor profile based on the rotor flank curve g3.

2. The method of claim 1, further comprising:
determining a rotor housing profile based on the conjugate curve g2.

3. The method of claim 1, wherein the generating curve g1 is an arc.

4. The method of claim 1, wherein the generating curve g1 represents a profile of a rotor seal.

5. The method of claim 4, wherein the rotor seal is a plurality of seals each having a seal profile, and the profile of the rotor seal represented by generating curve g1 is an outside envelope of the seal profiles of the plurality of seals.

6. The method of claim 5, further comprising incorporating into the rotor profile a plurality of slots, each slot configured for positioning one of a corresponding seal of the plurality of seals within the slot.

7. The method of claim 6, wherein at least one of the plurality of slots is further configured such that the corresponding seal is movable within the at least one slot, further comprising incorporating into the rotor a spring within the at least one slot, wherein the spring is configured to exert pressure on the corresponding seal.

8. The method of claim 1, wherein creating the conjugate curve g2 includes constraining the conjugate curve g2 such that a curve normal angle is continuously differentiable.

9. The method of claim 1, wherein the number of lobes of the rotor is three.

10. The method of claim 1, wherein the rotor is designed for use in a rotary engine with a 2:3 gear ratio.

11. A rotor, comprising:
a rotor body having a rotor profile including a plurality of apexes;
a plurality of slots in the rotor body, wherein at least one of the plurality of slots is positioned at each of the plurality of apexes; and
a plurality of seals, wherein each of the plurality of seals is positioned within a corresponding one of the plurality of slots, such that each of the plurality of apexes includes at least one of the plurality of seals;
wherein at least one of the plurality of seals at each apex has a seal profile described by a switch angle and a radius of the rotor body.

12. The rotor of claim 11, further comprising a plurality of springs, at least one of the plurality of springs being positioned in each of the plurality of slots, the at least one spring configured to exert a force against a seal positioned within the slot.

13. The rotor of claim 11, wherein at least two of the plurality of slots are positioned at each apex, and each of the at least two slots at each apex include one of the plurality of seals.

14. The rotor of claim 13, wherein, for each apex, the seal profile includes profiles of at least two seals.

15. The rotor of claim 11, wherein, at each apex, the seal profile is the profile of one seal.

16. A method of designing a rotor seal profile, comprising:
selecting a number of lobes;
defining a pitch curve having a radius r1;
defining a deviation function e1(θ) representing, for each pitch curve point at an angle θ, a radius of a circle centered at the pitch curve point;
identifying an envelope curve that describes an envelope of the deviation function e1(θ);
determining a curve normal function ψ(θ) related to the envelope curve;
determining a seal curve g1 from the envelope curve and the curve normal function ψ(θ), wherein the seal curve g1 represents a portion of the rotor seal profile.

17. The method of claim 16, wherein determining the seal curve g1 includes calculating a function g1(x,y) for an arc profile seal, wherein:
g1(x)=r1(cos θ)+(e1(θ)) (cos ψ); and
g1(y)=r1(sin θ)+(e1(θ)) (sin ψ).

18. The method of claim 16, wherein the seal curve g1 is not an arc.

19. The method of claim 16, wherein the seal profile width is greater than 2 mm.

20. The method of claim 16, wherein the seal profile width is greater than 10 mm.
